(19) United States
(12) Patent Application Publication
(10) Pub. No.: US 2015/0313785 A1
(43) Pub. Date: Nov. 5, 2015

(54) Therapeutic Spinal Traction Device

(71) Applicant: Cesar Nicola Shamas, Elk Grove, CA (US)

(72) Inventor: Cesar Nicola Shamas, Elk Grove, CA (US)

(21) Appl. No.: 14/268,223

(22) Filed: May 2, 2014

(51) Int. Cl. A61H 1/02

(52) U.S. Cl. CPC A61H 1/0296

(57) ABSTRACT

A therapeutic device for spinal traction has a modular assembly that allows an elongated base, a height-adjustable post, and a buttress to be used to adapt to individual preferences. The therapeutic device is designed to be easily adapted for use in a standing position or in a prone position. A head brace is connected by an extending member to an anchor, with multiple anchors being provided on the elongated base, the height-adjustable post, and potentially a projection member. The user places their head in the head brace and grasps the handle, pressing towards the buttress in order to create tension in the extending member and ultimately results in the creation of a targeted and isolated traction force. Thanks to the ease of assembly and adaption of the therapeutic device, it can be adjusted to fit personal characteristics of a wide range of persons.

### FIELD OF THE INVENTION

The present invention relates generally to a therapeutic apparatus for the cervical and thoracic portion of the spine. More specifically, the present invention allows the user to equally and evenly distribute a traction force about the cervical and thoracic portions of the spine in order to decompress intervertebral disks, for therapeutic purposes. Furthermore, the apparatus is collapsible and highly customizable; resulting in a device compatible with various body shapes.

### BACKGROUND OF THE INVENTION

The vertebral column, also known as the spine, is a column of twenty six bones located in the dorsal aspect of the upper portion of the human body. The vertebral column houses and protects the spinal cord and its associated channels and canals. Together, the brain and spinal cord make up the central nervous system, the processing center for the entire nervous system. The spinal cord acts as the conduit for the transmission of neural signals between the brain and the body, to and from. In addition, the spinal cord contains neural circuits which work independently of the brain to perform various reflex motions and control central pattern generators. Any damage to the neural pathways of the spinal cord can result in minor pain, crippling pain, paralysis, and even incontinence. Due to the critical functions of the central nervous system, spine health is of the utmost importance to the well being of an individual.

Trauma caused spinal injuries result in life-long complications and suffering. A major consequence and cause of the pain associated with such injuries is the dehydration of the intervertebral disks; the cushion-type joints which connect one vertebra to another. The soft and cushion type disks act as shock absorbers, absorbing the impact of the body's daily activities. The fibrocartilage layers of the disk ensure even pressure distribution during the bodies various activities. Spinal injuries can cause uneven distribution of pressure, herniated disks, and fractures vertebrae; resulting in immense pain and discomfort. One of the main purposes of the present invention is the therapeutical treatment of such injuries. More specifically, the present invention decompresses the vertebrae of the upper portion of the spine so as to facilitate the transfer of the necessary nutrients and resources to the intervertebral disks to expedite the healing process. Modern vertebrae decompression methods only work on the lumbar portion of the spine; the present invention is especially designed to compensate for this shortcoming by targeting the upper vertebrae of the spine. From the lateral perspective of the spine it can be observed that the thoracic and cervical portion contain opposite curvatures; creating an “S” shape. The present invention utilizes this “S” shape curvature of the upper portion of the spine to equally and evenly distribute a traction force about the top vertebrae of the spine.

### BRIEF DESCRIPTION OF THE DRAWINGS

FIG. 1 is a perspective view of a standing embodiment of the present invention in an upright position, with head brace and chest brace omitted for ease of disclosure.

FIG. 2 is a perspective view of the standing embodiment of the present invention in a reclined position, with head brace and chest brace omitted for ease of disclosure.

FIG. 3 is a right side elevation view of the standing embodiment of the present invention in an upright position, with head brace and chest brace omitted for ease of disclosure.

FIG. 4 is a right side elevation view of the standing embodiment of the present invention in a reclined position, with head brace and chest brace omitted for ease of disclosure.

FIG. 5 is a perspective view of the standing embodiment of the present invention in a reclined position, with chest brace omitted for ease of disclosure.

FIG. 6 is a right side elevation view of the standing embodiment of the present invention in a reclined position, with chest brace omitted for ease of disclosure.

FIG. 7 is a perspective view of the standing embodiment of the present invention in an upright position.

FIG. 8 is a right side elevation view of the standing embodiment of the present invention in an upright position.

FIG. 9 is a perspective view of the standing embodiment of the present invention in a reclined position.

FIG. 10 is a right side elevation view of the standing embodiment of the present invention in a reclined position.

FIG. 11 is a perspective view of a basic prone embodiment of the present invention, with head brace omitted for ease of disclosure.

FIG. 12 is a right side elevation view of the basic prone embodiment of the present invention, with head brace omitted for ease of disclosure.

FIG. 13 is a perspective view of an enhanced prone embodiment of the present invention, with head brace omitted for ease of disclosure.

FIG. 14 is a right side elevation view of the enhanced prone embodiment of the present invention, with head brace omitted for ease of disclosure.

FIG. 15 is a perspective view of the enhanced prone embodiment of the present invention.

FIG. 16 is a right side elevation view of the enhanced prone embodiment of the present invention.

FIG. 17 is a perspective view showing the standing embodiment of the present invention being used by a person.

FIG. 18 is a perspective view showing the basic prone embodiment of the present invention being used by a person.

FIG. 19 is a perspective view showing the enhanced prone embodiment of the present invention being used by a person.

### DETAIL DESCRIPTIONS OF THE INVENTION

All illustrations of the drawings are for the purpose of describing selected versions of the present invention and are not intended to limit the scope of the present invention.

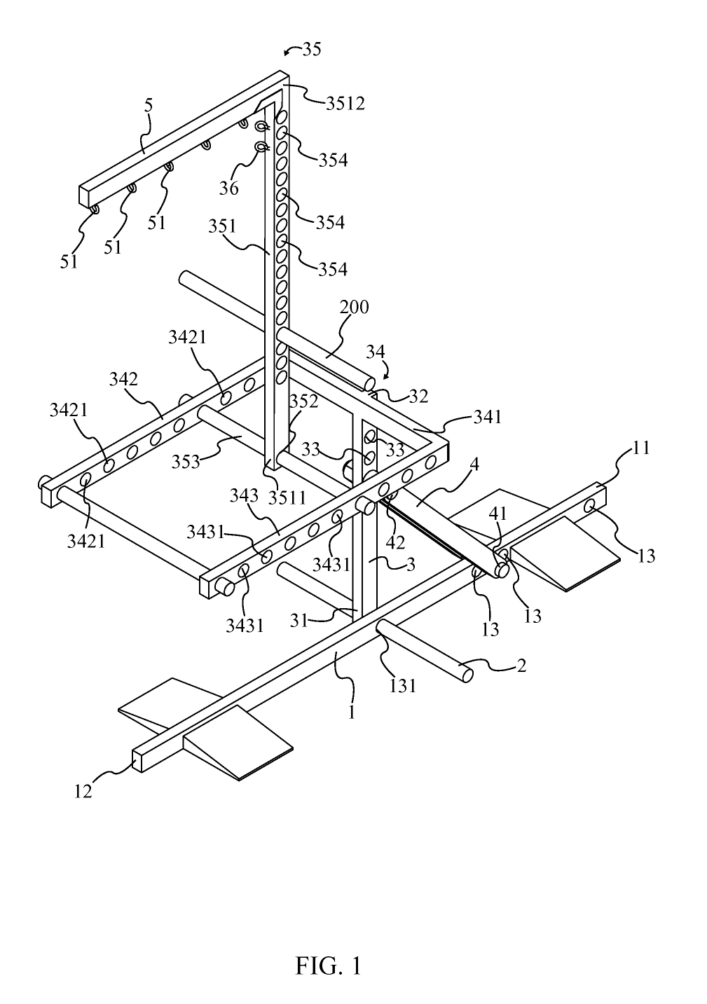

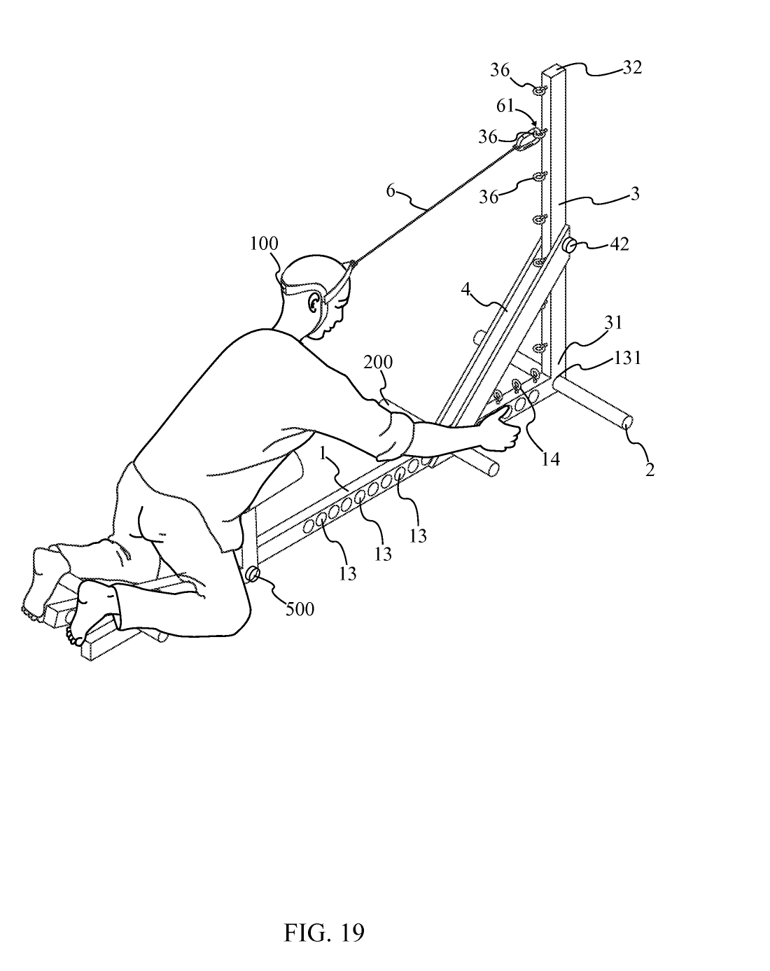

The present invention is a therapeutic apparatus provided for the treatment of spinal injuries. The present invention utilizes the shape of the spine to isolate and distribute a traction force about the upper vertebrae of the spine in order to elevate pressure of budging disks and prevent dehydration of the intervertebral disks; this is accomplished by the decompression of the disks via the present invention. The present invention allows the user to initiate and control the force of traction they are comfortable with and to isolate specific regions selected for traction in the cervical and/or thoracic spine. To this end, the present invention comprises an elongated base 1, a cross member 2, a height-adjustable post 3, a buttress 4, a head brace 100, and a handle 200. The elongated base 1 and the cross member 2 are placed on a flat surface in order to stabilize and support the rest of the present invention. The height-adjustable post 3 is hingedly connected to the elongated base 1 by the cross member 2, such that the angle between the height-adjustable post 3 and the elongated base 1 can be adjusted. The buttress 4 is angularly and hingedly attached to the height-adjustable post 3 by a first buttress pin 41; the buttress 4 is also selectively attached to the elongated base 1 by a second buttress pin 42. The buttress 4, first buttress pin 41, and second buttress pin 42 reinforce and secure the height-adjustable post 3 at a desired angle. Supplementary components and configurations can be provided in addition to the aforementioned components in order to create different embodiments of the present invention. The present invention, including possible embodiments and examples of use, is illustrated in FIG. 1—FIG. 19.

The elongated base 1 comprises a first base end 11, a second base end 12, and a plurality of base holes 13. Similarly, the height-adjustable post 3 comprises first post end 31, a second post end 32, and a plurality of post holes 33. The buttress 4 comprises a first buttress hole 43 and a second buttress hole 44 which are respectively provided to receive the first buttress pin 41 and the second buttress pin 42. Provided for both additional support and to secure the height-adjustable post 3 to the base, the cross member 2 is selectively engaged with a desired pivot hole 131 of the plurality of base holes 13. The cross member 2 is also selectively engaged with a post pivot hole 331 of the plurality of post holes 33, such that the cross member 2 traverses through the first post end 31. Effectively, the cross member 2 is used to connect the height-adjustable post 3 to the elongated base 1 at any desired position along the elongated base 1, accomplished by means of the desired pivot hole 131 and the post pivot hole 331. For example, the cross member 2 could be positioned across the center of the elongated base 1, at the first base end 11, or at the second base end 12. The height-adjustable post 3 can be rotated about the cross member 2, allowing the angle between the elongated base 1 and the height-adjustable post 3 to be adjusted. The configuration of the elongated base 1, cross member 2, and height-adjustable post 3 is designed to be easily adjustable in order to accommodate individual preferences and to facilitate alternative embodiments of the present invention.

The buttress 4 is used to secure the elongated base 1 and cross member 2 in a desired configuration. The buttress 4 also supports the height-adjustable post 3 by acting as a load bearing member. In order to secure the elongated base 1 and height-adjustable post 3, the first buttress 4 traverses through the first buttress hole 43 and the post pivot hole 331 while the second buttress pin 42 traverses through the second buttress hole 44 and the desired pivot hole 131. The first buttress pin 41 and the second buttress pin 42 serve to lock the elongated base 1 and the cross member 2 at a desired angle.

Additionally, the first buttress pin 41 and the second buttress pin 42 can easily be removed to allow a user to reposition the elongated base 1 and cross member 2. As previously mentioned, the adjustable nature is supported by the plurality of base holes 13, plurality of post holes 33, the first buttress hole 43, and the second buttress hole 44; these holes are distributed to allow the present invention to better adapt to individual differences. The plurality of base holes 13 is positioned along the elongated base 1, with the plurality of base holes 13 traversing through the elongated base 1. Likewise, the plurality of post holes 33 is positioned along the height-adjustable post 3, as well as traversing through the height-adjustable post 3. These holes are necessary as they allow the elongated base 1, the height-adjustable post 3, and the buttress 4 to interface with each other via the cross member 2, the first buttress pin 41, and the second buttress pin 42.

The present invention as thus described provides a base structure which can be expanded upon to create different embodiments of the present invention, e.g. for use in a standing or prone position. A standing embodiment will subsequently be described, followed by a description of a prone embodiment.

In the standing embodiment a supporting frame 34 is provided for connection to the height-adjustable post 3 as well as for supporting an extending assembly 35. The supporting frame 34 comprises a mounting portion 341, a first beam 342, and a second beam 343, the first of which is connected to the height-adjustable post 3 and the latter two of which are used to help secure the extending assembly 35. The extending assembly 35 comprises an extending frame 351, a frame hole 353, an extension shaft 353, and a plurality of handle-receiving holes 354. In order to receive the extension shaft 353, and thus join the extending assembly 35 to the supporting frame 34, the first beam 342 comprises a first plurality of beam holes 3421 and the second beam 343 comprises a second plurality of beam holes 3431.

In order to join supporting frame 34 to the height-adjustable post 3 and the extending assembly 35 to the supporting frame 34, the following relations are defined. The mounting portion 341 is adjacently connected to the height-adjustable post 3, opposite the elongated base 1. The first beam 342 and the second beam 343 are adjacently connected to the mounting portion 341, positioned opposite each other along the mounting portion 341. The first beam 342 and the second beam 343 are parallel to each other and perpendicular to the mounting portion 341. Overall, the mounting portion 341, first beam 342, and second beam 343 combine to form a U-shape. The extension shaft 353 is selectively engaged with one of the first plurality of beam holes 3421 as well as one of the second plurality of beam holes 3431. The extension shaft 353 can easily be removed from and inserted into pairs of concentric beam holes, allowing a user to adjust the position of the extension shaft 353 to their preference. As the extending frame 351 is hingedly connected to the extension shaft 353, any repositioning of the extension shaft 353 results in a corresponding shift of the extending frame 351. In order to provide optimal positioning for the head brace 100, a projection 5 is perpendicularly and adjacently connected to the extending frame 351. The projection 5 is positioned at a distal end 3512 of the extending frame 351, opposite the extension shaft 353 of the proximal end 3511. The projection 5 comprises at least one projection anchor 51 that is provided for securing the head brace 100. The frame hole 353 is positioned at the proximal end 3511 of the extension shaft 353, traversing through the extending frame 351 in order to serve as a receptacle for the extension shaft 353. The extension shaft 353 itself traverses through the frame hole 353, completing the joining of the extending assembly 35 to the supporting frame 34. The plurality of handle-receiving holes 354 is positioned along the extending frame 351 and allows the handle 200 to be secured. The plurality of handle-receiving holes 354 traverses through the extending frame 351, allowing the handle 200 to be selectively engaged with one of the plurality of handle-receiving holes 354. The head brace 100 is selectively coupled to an active anchor 61 from the provided projection anchors 51, the active anchor 61 being one that is best suited to a given individual's physical characteristics. The coupling is completed via an extending member 6, which is secured to the head brace 100 at one end and the active anchor 61 at an opposite end. A first plurality of beam holes 3421 and a second plurality of beam holes 3431 allow for the extending assembly 35 to be moved forward or backward along the supporting frame 34, accommodating variances in preferences and physical characteristics. Thus the first plurality of beam holes 3421 is positioned along the first beam 342, additionally traversing through said first beam 342. Paralleling this, the second plurality of beam holes 3431 is positioned along and traverses through the second beam 343.

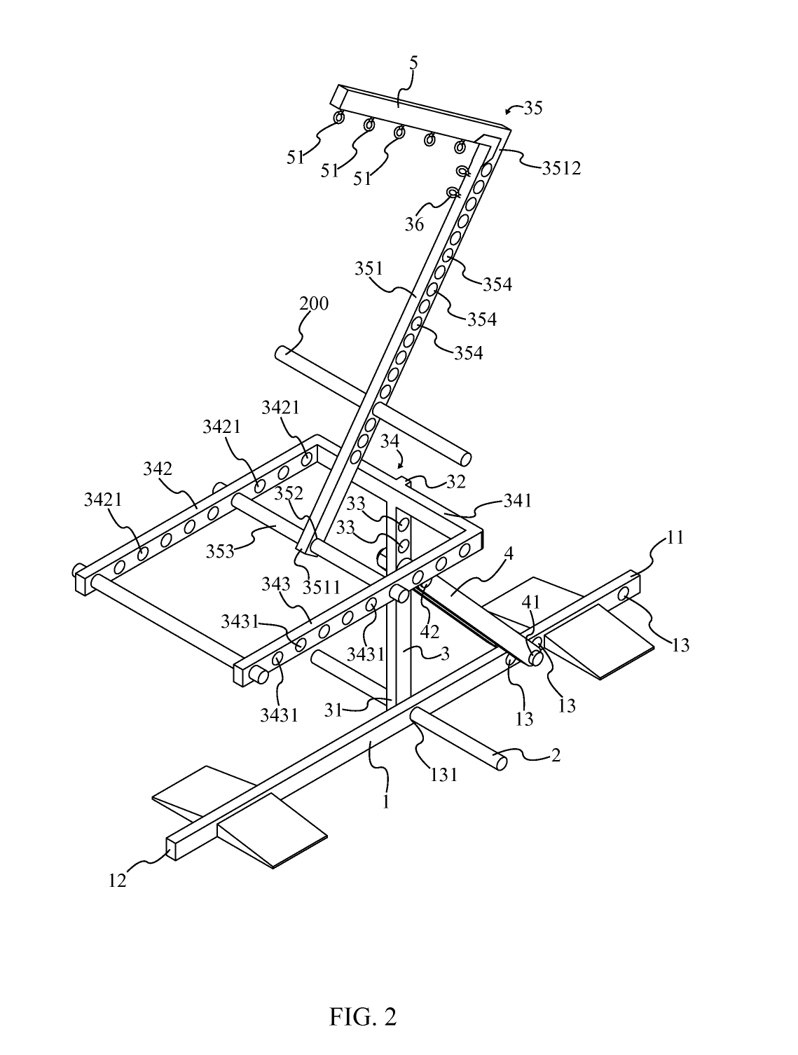

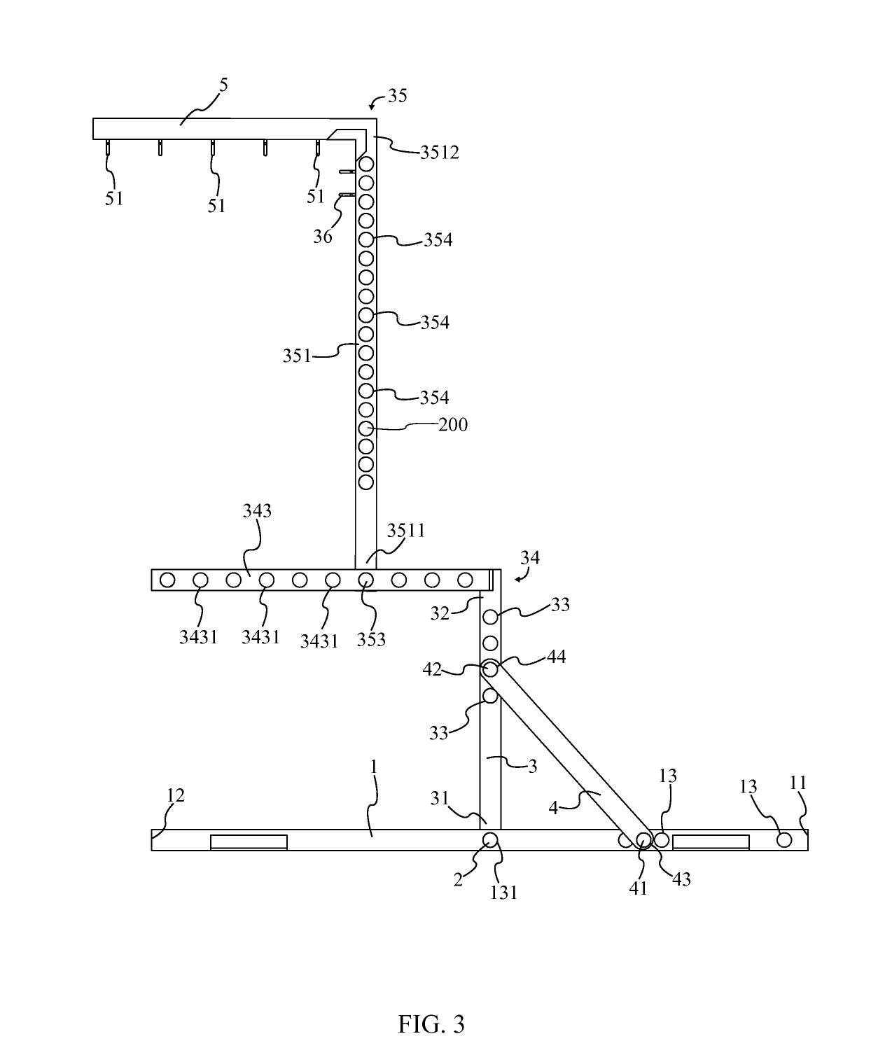

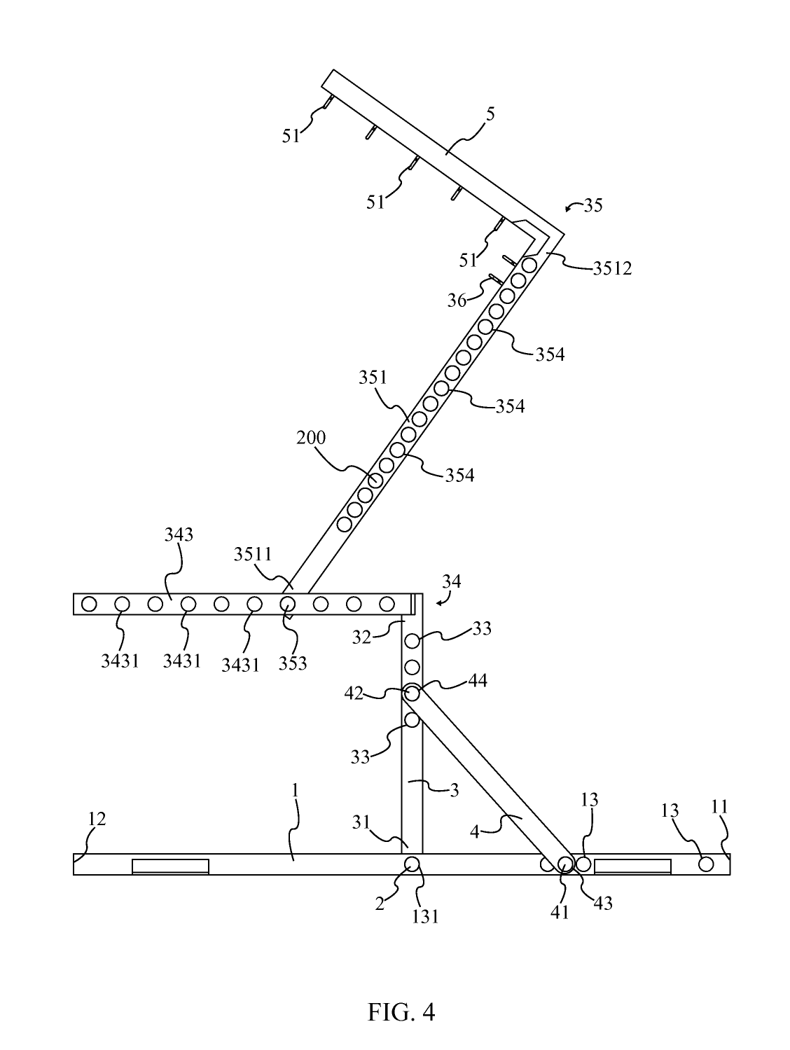

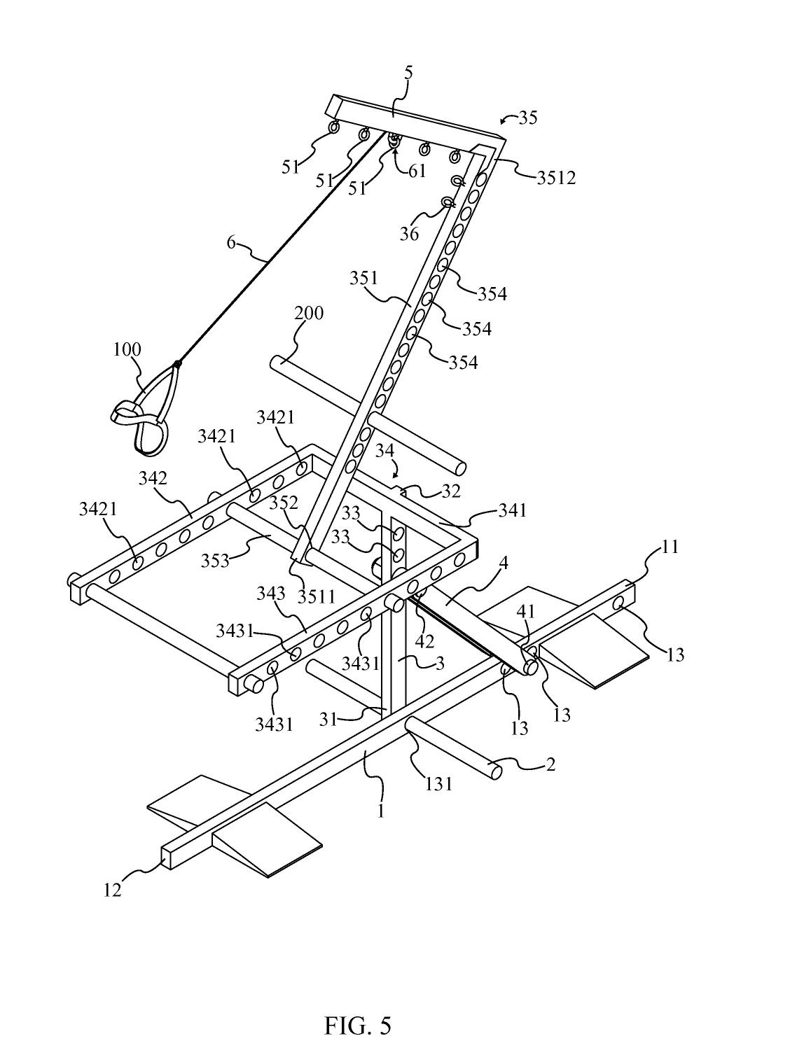

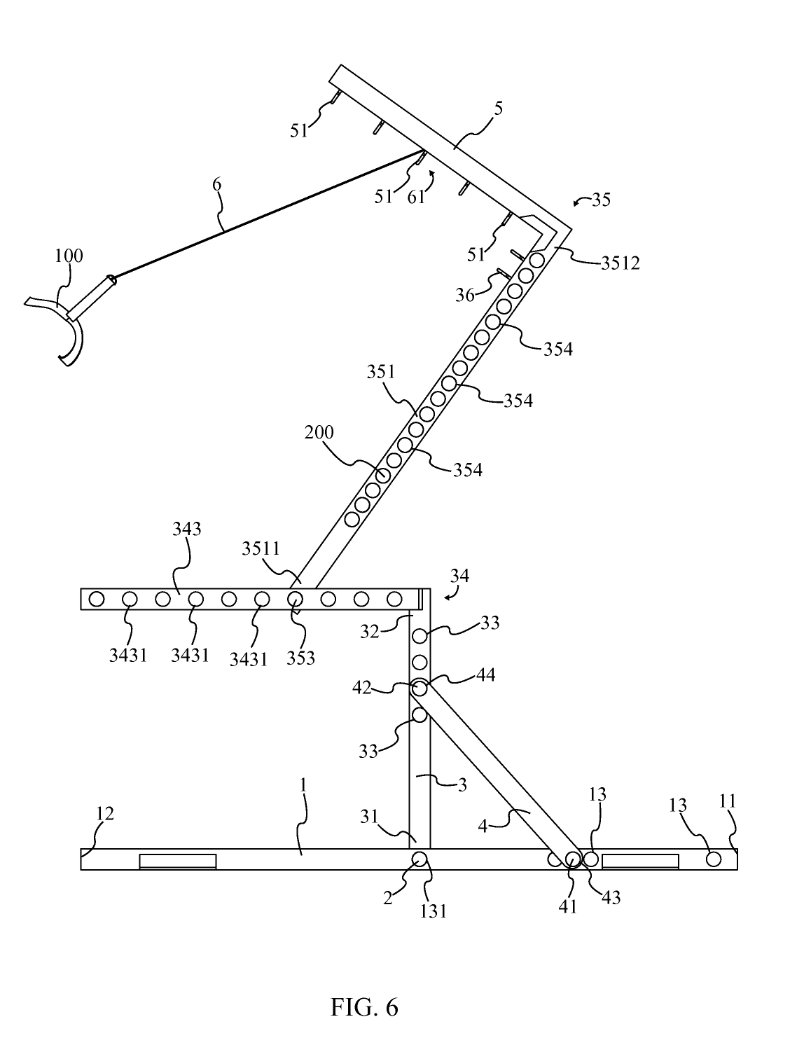

The standing embodiment, as thus far described, allows a person to lean forward against the supporting frame 34, such that their body forms a hypotenuse triangle with respect to the elongated base 1 and the height-adjustable post 3. A traction force is created as the user grasps the handle 200 and pushes the extending assembly 35 forwards, corresponding in tension in the extending member 6 that ultimately causes the head brace 100 to pull on the user's head. Preferably, the extending member 6 is arched for increased user ergonomics, though it can be produced as a straight member and is illustrated as such for ease of disclosure. This standing embodiment as thus far described is illustrated in FIG. 1-FIG. 6.

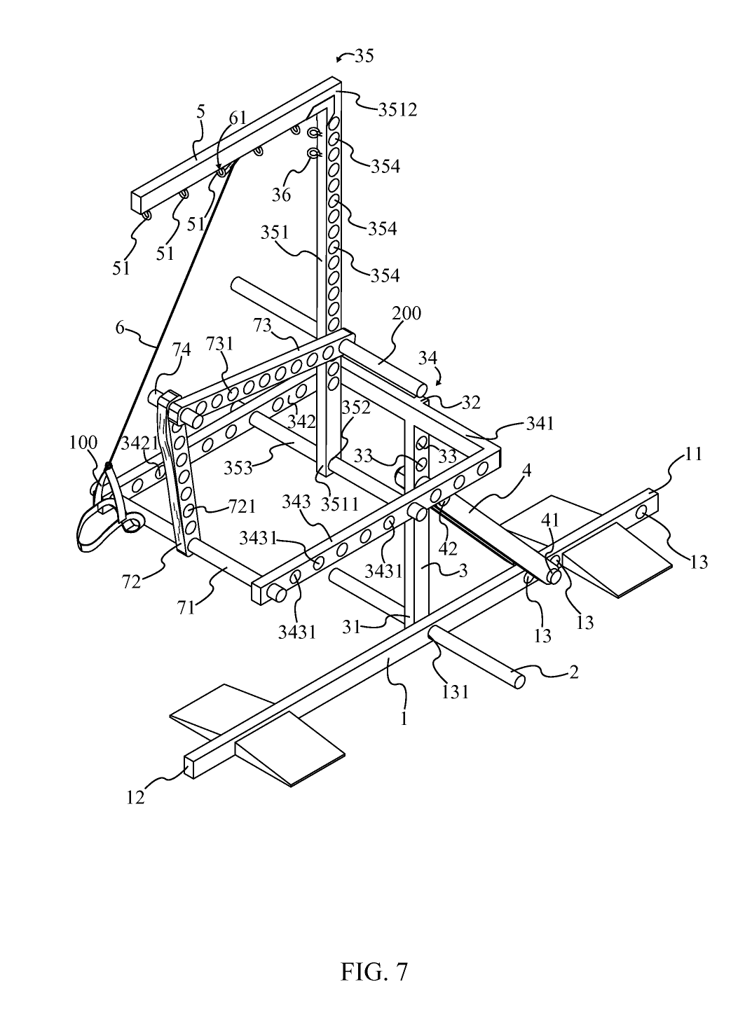

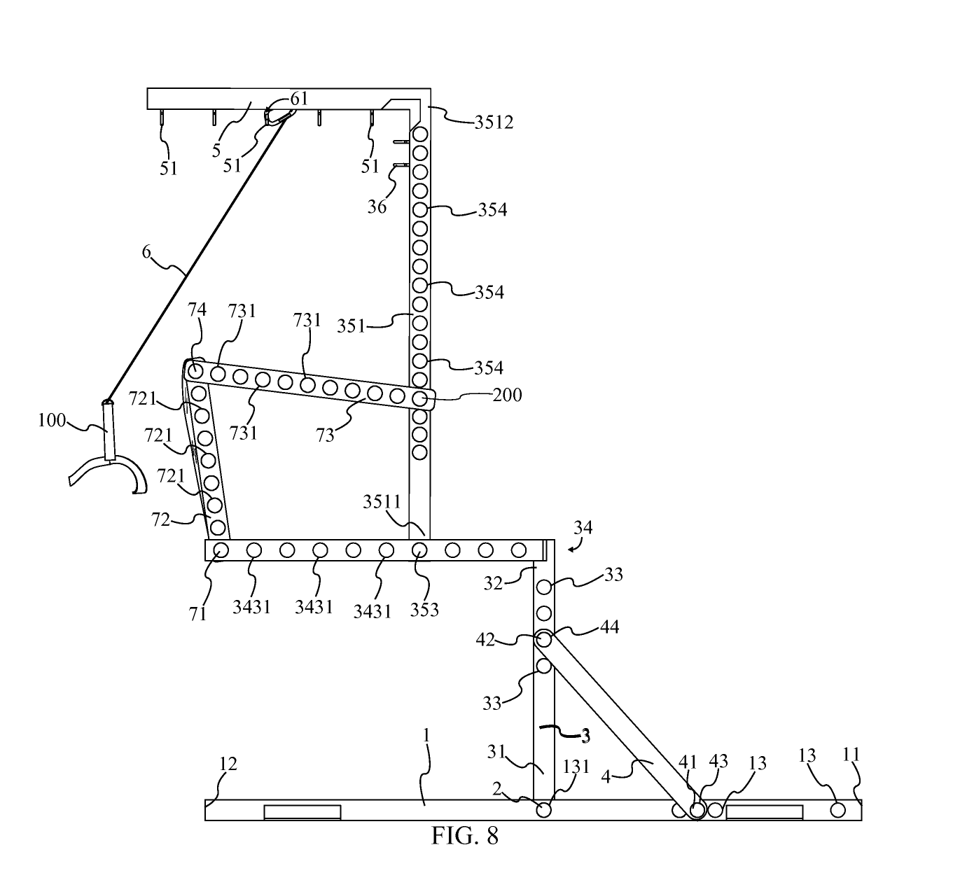

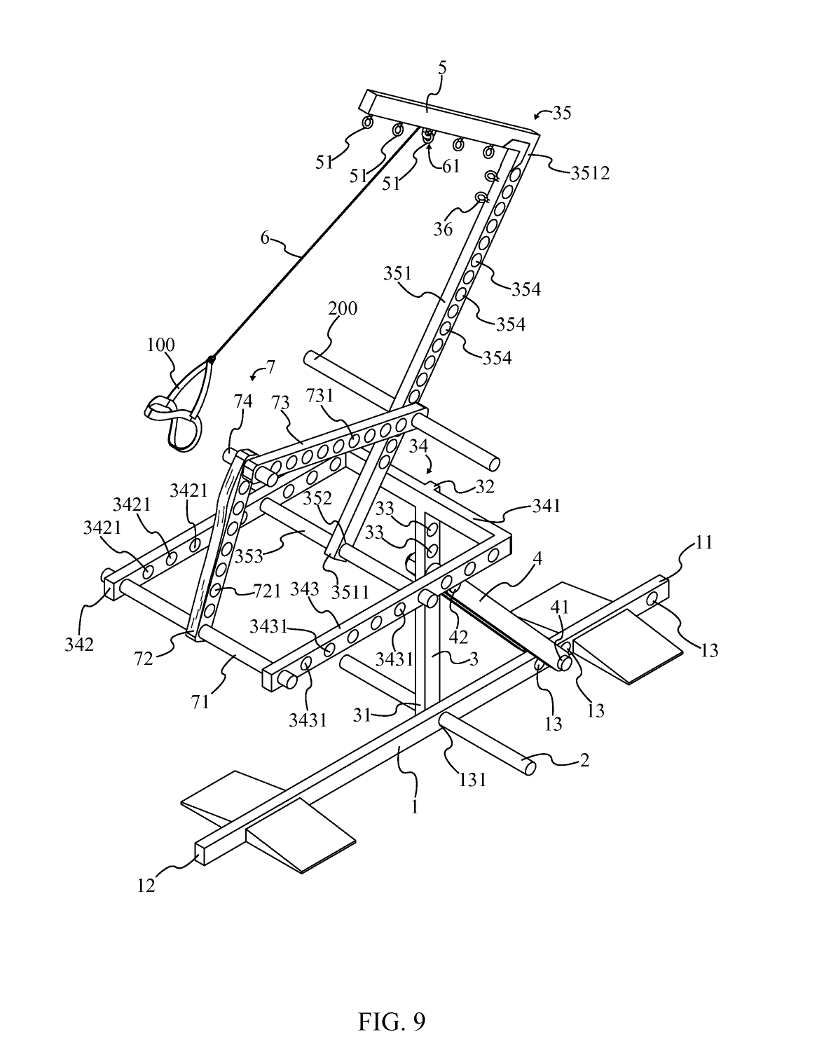

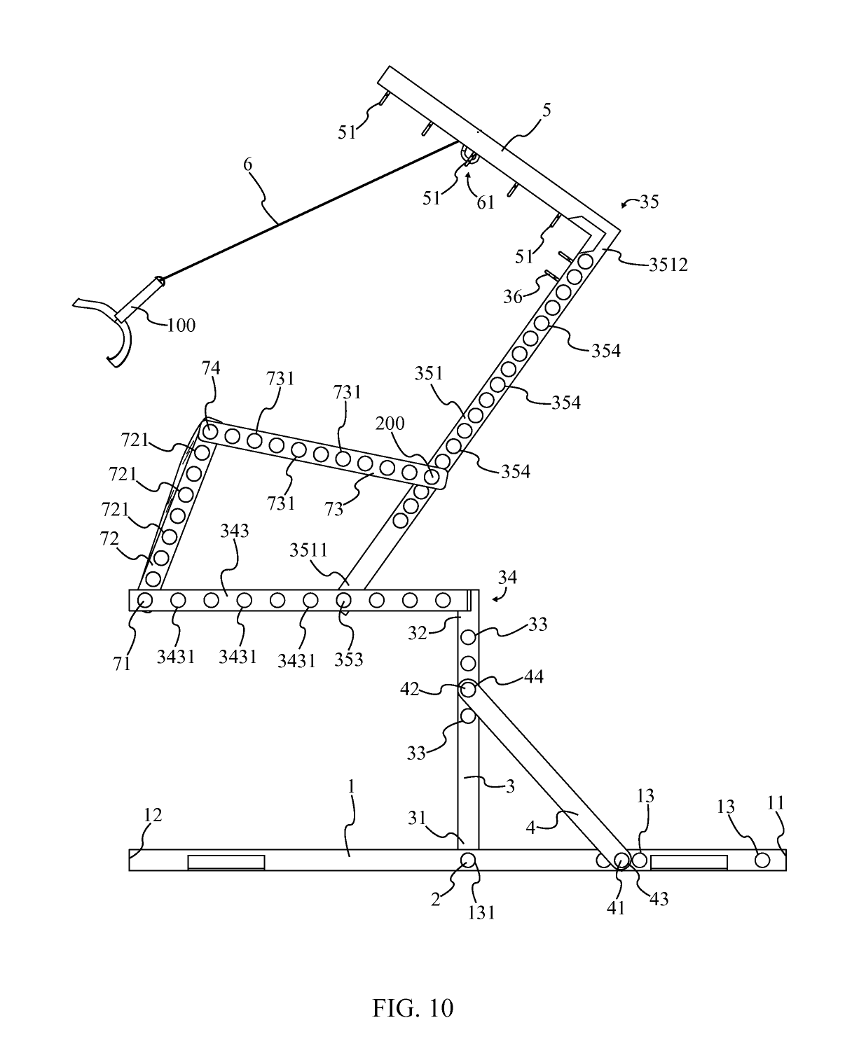

The standing embodiment can be improved upon through the addition of a chest brace assembly 7, as illustrated in FIG. 7-FIG. 10. Provided to press back against the torso and keep it in an ideal position. The chest brace, assembly 7, allows for user controlled pressure, dependant forward angel of lean, against the sternum which is transferred to the thoracic spine via the ribs and allows for greater separation and isolation of the thoracic vertebrae. The chest brace assembly 7 comprises a chest shaft 71, a first arm 72, and a second arm 73. Allowing for position adjustments, the first arm 72 comprises a first plurality of arm holes 721 and the second arm 73 comprises a second plurality of arm holes 731. The chest brace assembly 7 is secured by being connected to the supporting frame 34 and the extending assembly 35; this connection is provided at two points. The chest shaft 71 serves as one point of connection and is selectively engaged with one of the first plurality of beam holes 3421 and one of the second plurality of beam holes 3431, allowing for its rotation with respect to the supporting frame 34. The first arm 72 is hingedly connected with the chest shaft 71, with the second arm 73 being positioned at an end of the first arm 72 which is opposite the chest shaft 71. The second arm 73, at a first end, is hingedly connected with the first arm 72 and at an opposite end is hingedly connected to the extending frame 351, away from the first arm 72. These connection allow the first arm 72 and the second arm 73 to rotate and flex along with the extending assembly 35, and also provides a supportive member a user can press and steady their chest against. Providing such a supportive element for the chest is important as it acts to isolate the thoracic spine, rather than compressing the thoracic spine as is done in a number of prior art.

Allowing for adjustments in the configuration of the chest shaft 71, first arm 72, and second arm 73, the first plurality of arm holes 721 is positioned along and traverses through the first arm 72 while the second plurality of arm holes 731 is positioned along and traverses through the second arm 73. The hinged connection is achieved by an arm pin 74 that traverses through paired holes, one from the first plurality of arm holes 721 and another from the second plurality of arm holes 731. This allows the pivot point between the first arm 72 and the second arm 73 to be adjusted by removing the arm pin 74 and aligning a new pair of holes, and reinserting the arm pin 74. Similarly, the chest shaft 71 can be moved between pairs of beam holes, further accommodating individual needs and preferences. In fact, the chest brace assembly 7 is entirely optional; the standing embodiment can be used with or without the chest brace assembly 7 as desired by a user. The components of the chest brace assembly 7 allow for easy assembly and disassembly, in support of its optional use.

Potentially, elastic bands may be attached between the chest shaft 71 and the handle 200. These elastic bands increase resistance during use of the present invention.

The increased resistance improves the treatment aspect of the present invention. Though illustrated in FIG. 7-FIG. 10 as being used with the chest shaft 71 and handle 200, elastic bands can be connected between any two components of the present invention. It is noted that one of the components must be stationary while the other must rotate, as the movement of the rotating component stretches the elastic band, creating tension and thus greater resistance.

While the present invention has been described with the standing embodiment, the prone embodiment can be implemented through addition of a different group of supplemental components to the core assembly. This prone embodiment provides a number of components to support a user in a non-standing position, omitting the supporting frame 34, extending assembly 35, chest brace assembly 7, and projection 5 of the standing embodiment. Instead, in the prone embodiment the elongated base 1 and the extending member 6 are expanded upon. A foot support 300 and anterior torso brace 400 are also provided to improve user ergonomics. The components and configuration of this prone embodiment are subsequently described in greater detail.

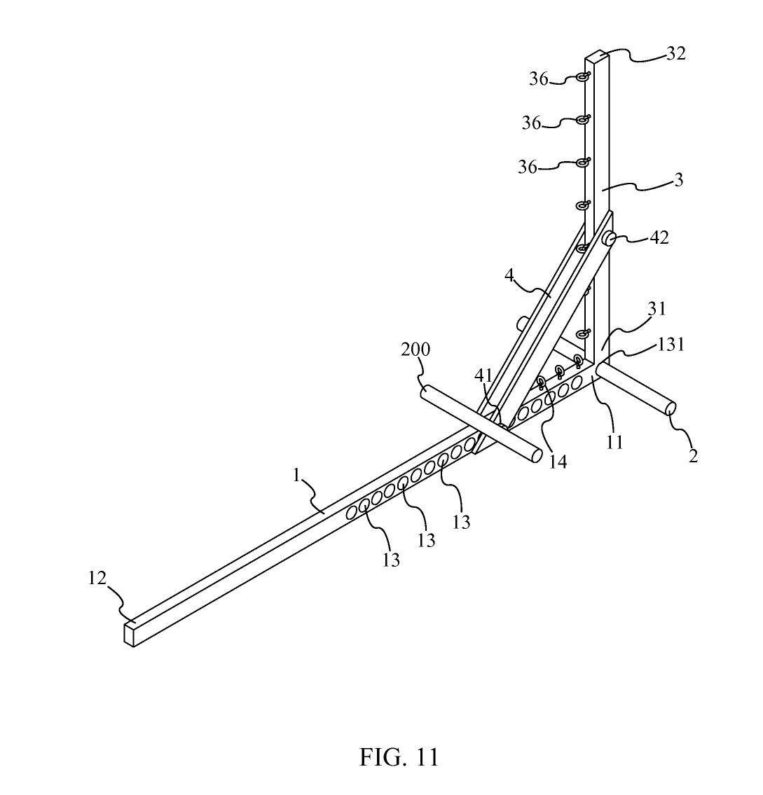

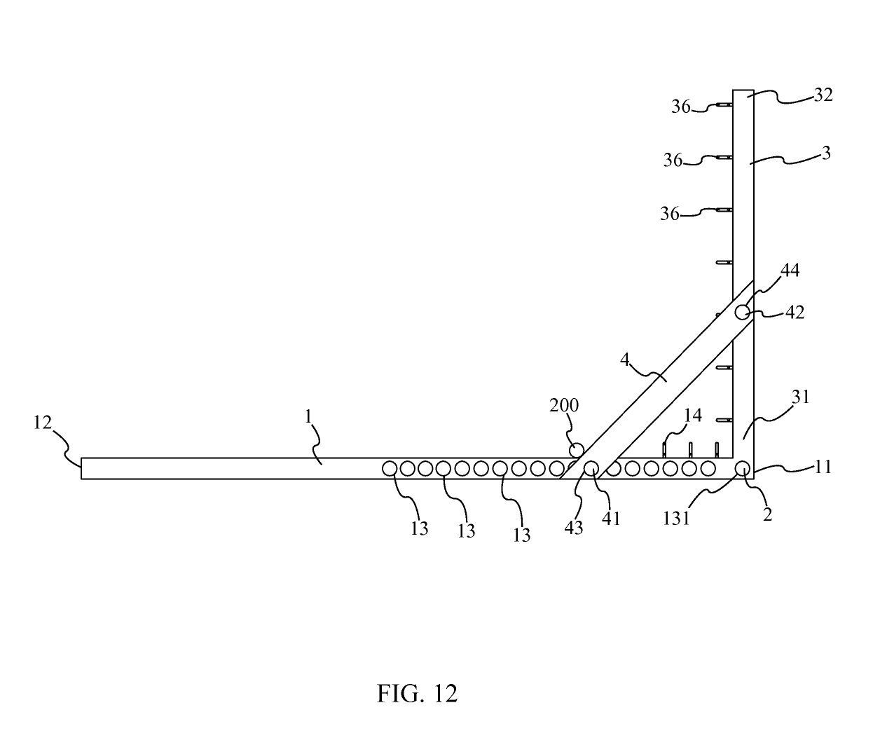

In the prone embodiment the elongated base 1 comprises at least one base anchor 14, providing a potential attachment point for the head brace 100. This base anchor 14 is mounted to the elongated base 1, at a position which is adjacent to the second base end 12. Similarly, the height-adjustable post 3 comprises at least one post anchor 36. The post anchor 36 is mounted to the height-adjustable post 3 and positioned adjacent to the first post end 31. The base anchor 14 and the post anchor 36 allow a user to select a desirable anchor that will provide the best angle for the head brace 100. An active anchor 61, selected from the at least one base anchor 14 or the at least one post anchor 36, is used to secure the head brace 100. As with the standing embodiment, the head brace 100 is selectively coupled to the active anchor 61 through an extending member 6. Whether the active anchor 61 is selected from the at least one base anchor 14 of from the at least one post anchor 36, the coupling of the head brace 100 and the active anchor 61 is achieved through the same means. The extending member 6 is attached to both the head brace 100 and the active anchor 61, with the head brace 100 and active anchor 61 being positioned opposite each other along the extending member 6. This basic prone embodiment is shown in FIG. 11 and FIG. 12.

In the prone embodiment the handle 200 is not physically secured to another component, unlike the standing embodiment in which the handle 200 inserted into one of the plurality of handle-receiving holes 354. Instead, in the prone embodiment, the handle 200 is held by a user and pressed against the buttress 4. Doing so helps create the desired traction force, as pressing the handle 200 against the buttress 4 creates tension in the extending member 6 which ultimately results in force being experienced by a person wearing the head brace 100.

An anterior torso brace 400 and the foot support 300 are provided to provide an ergonomic means for supporting a user as well as assisting with the creation of the traction force. Each of these components is secured to the elongated base 1. The anterior torso brace 400 comprises a brace hole 410 and the foot support 300 comprises a foot hole 310 for use in said securing. A locking pin 500 is provided to be inserted through these holes and one of the holes on the elongated base 1 in order to secure the anterior torso brace 400 and the foot support 300 to the elongated base 1. The positioning of the anterior torso brace 400 and the foot support 300 are adjustable with respect to the elongated base 1. The user can move the anterior torso brace 400 and the foot support 300 forward or backward along the elongated base 1. At the desired position, where a desired hole 332 of the plurality of base holes 13 is identified, the anterior brace support is positioned such that the brace hole 410 is concentric with the desired hole 332 and the foot hole 310 being concentrically aligned with the brace hole 410. It is noted that by proxy the foot hole 310 is also concentrically aligned with the desired hole 332. With respect to the elongated base 1 as a whole, the anterior torso brace 400 and the foot support 300 are positioned adjacent to each other and opposite the cross member 2; this positioning provides sufficient space for a user to press the handle 200 against the buttress 4 (the latter of which is adjacent to the cross member 2) while maintaining an ideal body posture. Allowing for ideal body posture is important as it helps optimize the created traction force. The locking pin 500, as referenced earlier, helps secure the anterior torso brace 400 and the foot support 300 in the desired position. The locking pin 500 traverses through the brace hole 410, the foot hole 310, and the desired hole 332, preventing any undesired deviations from the selected position.

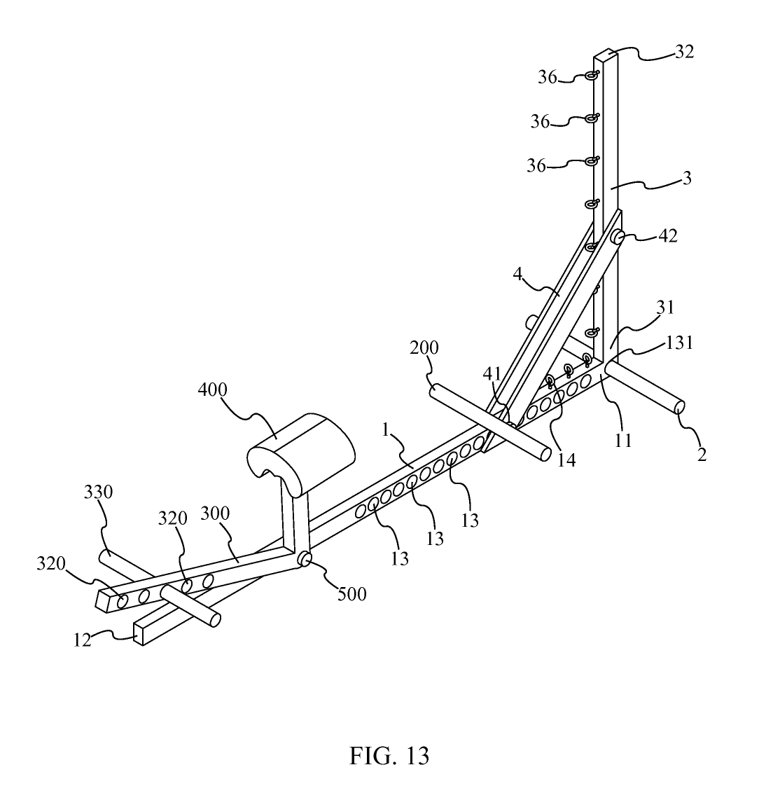

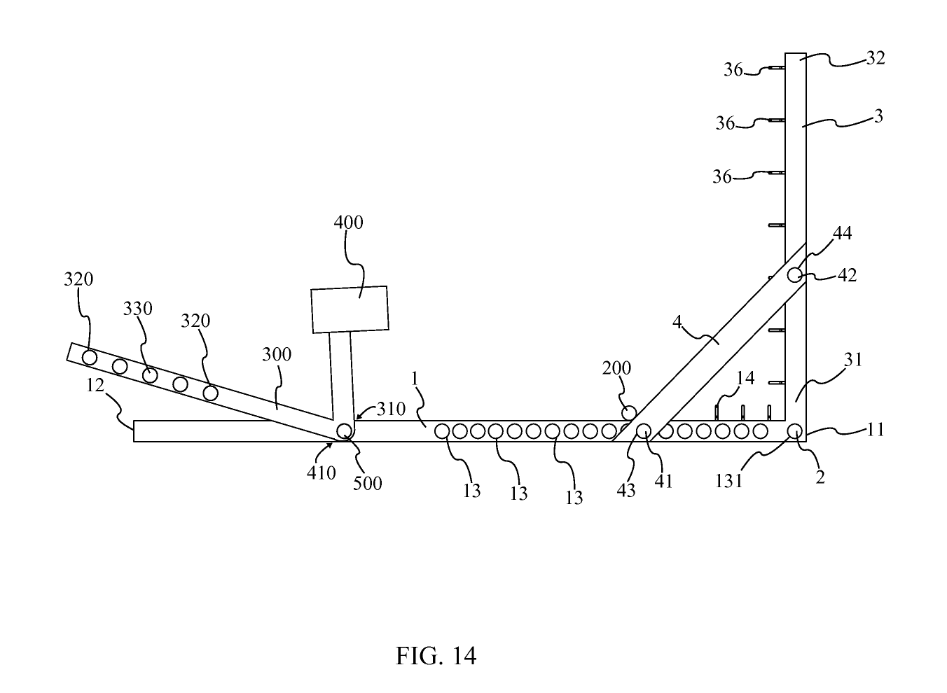

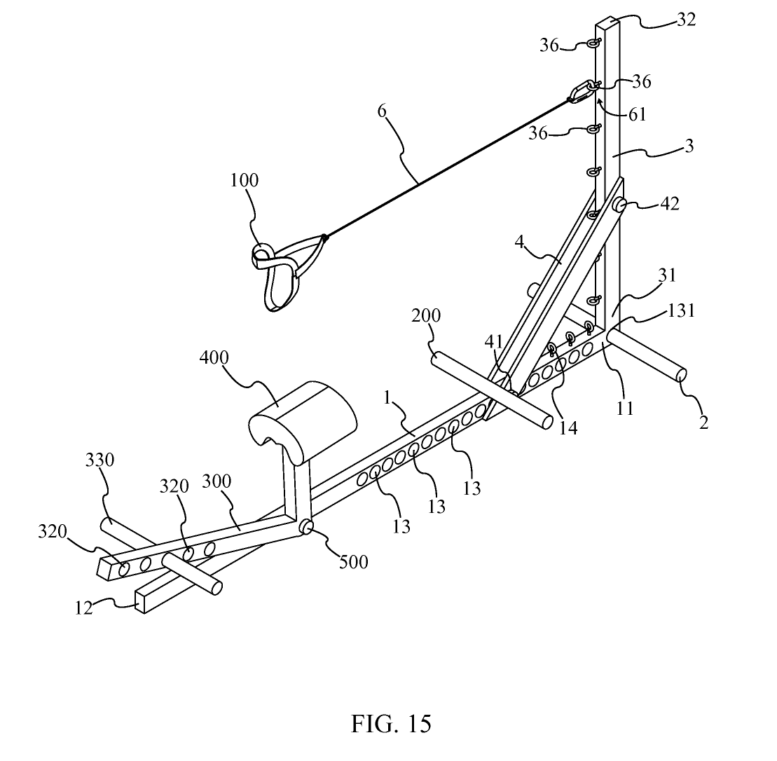

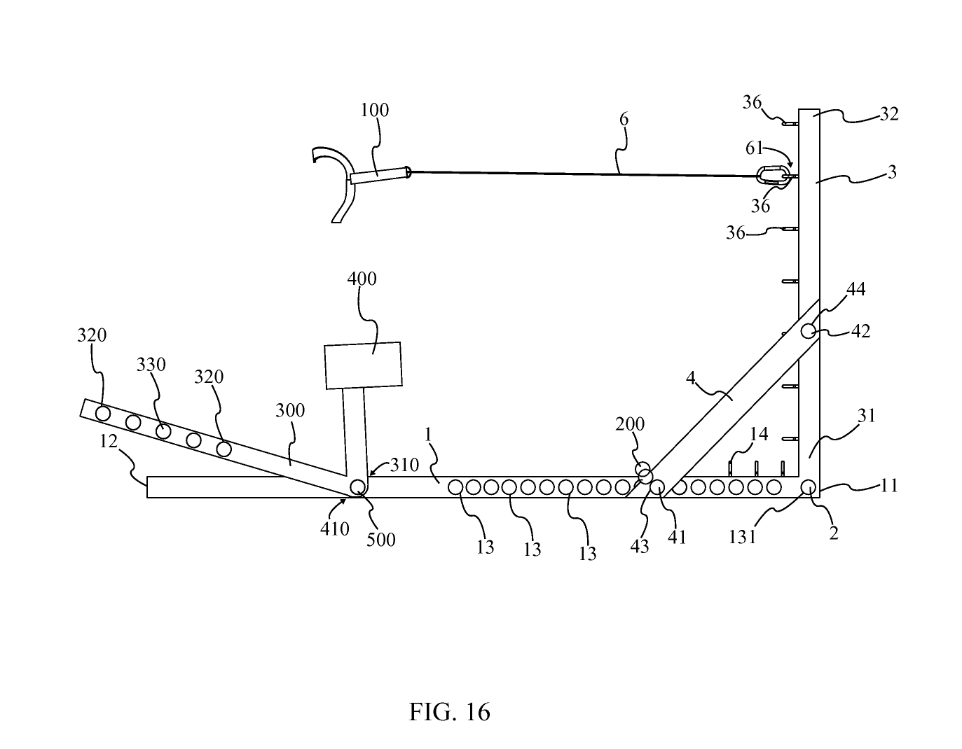

The foot support 300 is itself adjustable in order to accommodate for different user heights. The foot support 300 comprises a plurality of support holes 320 and a foot rest 330, with the plurality of support holes 320 being positioned along the foot support 300. The plurality of support holes 320 traverse through the foot support 300, providing a number of potential positions for the foot rest 330. The foot rest 330 is thus selectively engaged with one of the plurality of support holes 320, being inserted into a selected hole which is appropriate for that individual's height and personal comfort. This expanded prone embodiment is illustrated in FIG. 13-FIG. 16.

While the prone embodiment has been described with the anterior torso brace 400 and the foot support 300, a simpler version of the prone embodiment omits said components. Instead of resting their body across the anterior torso brace 400 and the foot support 300, the user kneels on the ground. Otherwise, the operation of the prone embodiment is the same regardless of the presence or omission of the anterior torso brace 400 and the foot support 300. The user, in a prone orientation, presses the handle 200 against the buttress 4 in order to create a traction force via the head brace 100 and extending member 6. This core basic operation is the same as with the standing embodiment, although each embodiment has benefits compared to the other. For example, by utilizing the anterior torso brace 400 and the foot support 300 the prone embodiment is able incorporate additional cervical and thoracic traction, resulting from force multiplication via the anterior torso brace 400 and the foot support 300. As referred to earlier, illustrations of the more basic version are provided in FIG. 11 and FIG. 12.

The present invention, in all embodiments, is designed to easily be adaptable to differences in preferences and physical characteristics between users. The use of holes, pins, and shafts is the most notable example of this. Many individual components have at least one hole that can be aligned with a hole from another component and locked in place by a corresponding pin or shaft. These pins and shafts are easily removed and inserted into a different pair of holes, allowing a user to increase or decrease distance between two components and to adjust the angle between select components. Similarly, the head brace 100 can easily be switched between anchors by detaching and reattaching the connecting member from one active anchor 61 to another. Preferably this is accomplished with a simple and user-friendly adapter, such as a carabiner. However, in other embodiments of the present invention different methods of securing the head brace 100 to the anchor may be used. Indeed, in some alternative embodiments different methods can also be used for connecting individual components. For example, rather than using a combination of holes, pins, and shafts to secure components to each other, a rail system with clamps can be used to allow movement and locking of individual components. The present invention can also be reinforced, such as by connecting feet to the elongated base 1 or providing cross braces for the supporting frame 34. These connecting feet could provide a more stable base while the cross braces can more evenly spread a load (such as applied during use of the present invention) between the first beam 342 and the second beam 343.

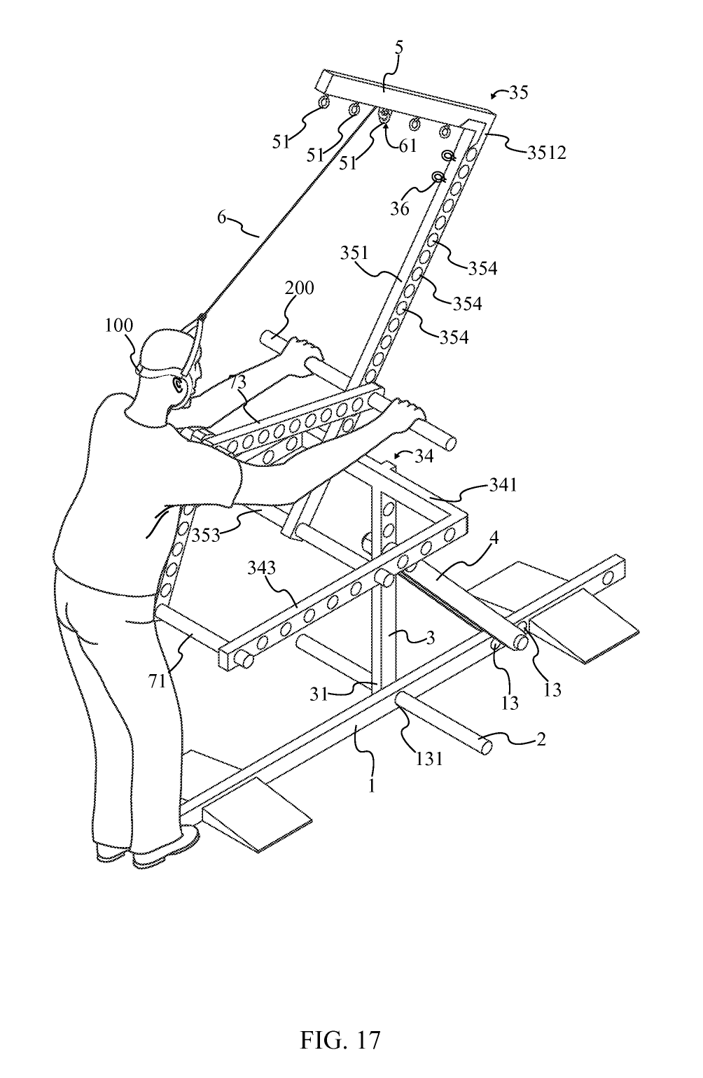

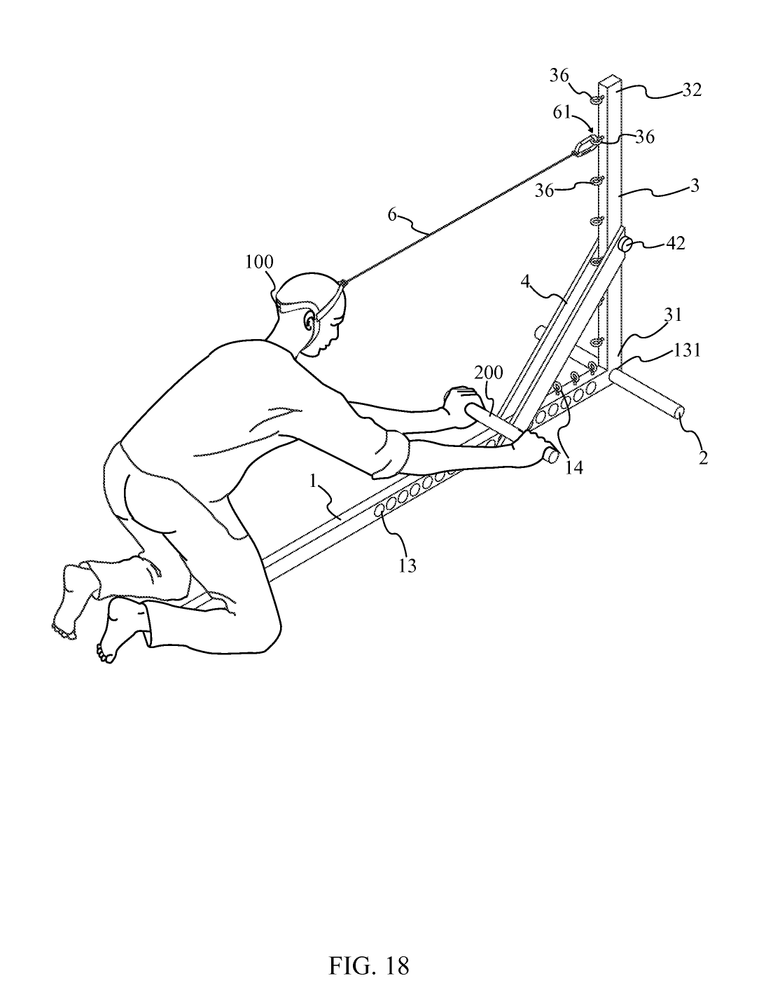

Though the present invention can be adapted for individual purposes, it is primarily designed for spinal treatment and its usage therefore is illustrated in FIG. 17-FIG. 19. These figures illustrate how the present invention is preferably used for each of the three main embodiments.

Although the invention has been explained in relation to its preferred embodiment, it is to be understood that many other possible modifications and variations can be made without departing from the spirit and scope of the invention as hereinafter claimed.

What is claimed is:

1. A therapeutic spinal traction device comprises:
an elongated base;
a cross member;
a height-adjustable post;
a buttress;
a head brace;
a handle;
the height-adjustable post being hingedly connected to the elongated base by the cross member;
the buttress being angularly and hingedly attached to the height-adjustable post by a first buttress pin; and
the buttress being selectively attached to the elongated base by a second buttress pin.

2. The therapeutic spinal traction device as claimed in claim 1 comprises:
the elongated base comprises a first base end, a second base end, and a plurality of base holes;
the height-adjustable post comprises a first post end, a second post end, and a plurality of post holes;
the buttress comprises a first buttress hole and a second buttress hole;
the cross member being selectively engaged with a desired pivot hole of the plurality of base holes and a post pivot hole of the plurality of post holes, wherein the cross member traverses through the first post end;
the first buttress pin traversing through the first buttress hole and the post pivot hole; and
the second buttress pin traversing through the second buttress hole and the desired pivot hole.

3. The therapeutic spinal traction device as claimed in claim 2 comprises:
the plurality of base holes being positioned along the elongated base;
the plurality of post holes being positioned along the height-adjustable post;
the first buttress hole and the second buttress hole being positioned opposite of each other along the buttress;
the plurality base holes of traversing through the elongated base;
the plurality of post holes traversing through the height-adjustable post; and
the first buttress hole and the second buttress hole each traversing through the buttress.

4. The therapeutic spinal traction device as claimed in claim 1 comprises:
a supporting frame;
an extending assembly;
the supporting frame comprises a mounting portion, a first beam, and a second beam;
the extending assembly comprises an extending frame, a frame hole, an extension shaft, and a plurality of handle-receiving holes;
the first beam comprises a first plurality of beam holes;
the second beam comprises a second plurality of beam holes;
the mounting portion being adjacently connected to the height-adjustable post opposite the elongated base;
the first beam and the second beam being perpendicularly and adjacently connected to the mounting portion;
the first beam and the second beam being positioned opposite each other along the mounting portion;
the extension shaft being selectively engaged with one of the plurality of first beam holes and being selectively engaged one of the plurality of second beam holes; and
the extending frame being hingedly connected to the extension shaft.

5. The therapeutic spinal traction device as claimed in claim 4 comprises:
a projection;
the projection comprises an at least one projection anchor;
the projection being perpendicularly connected adjacent to the extending frame;
the projection being positioned adjacent to a distal end of the extending frame;
the frame hole being positioned on a proximal end of the extending frame;
the plurality of handle-receiving holes being positioned along the extending frame;
the frame hole traversing through the extending frame;
the extension shaft traversing through the frame hole;
the plurality of handle-receiving holes traversing through the extending frame;
the handle being selectively engaged with one of the plurality of handle-receiving holes; and
the head brace being selectively coupled through an extending member to an active anchor, wherein the active anchor is selected from the at least one projection anchor.

6. The therapeutic spinal traction device as claimed in claim 5 comprises:
the extending member being attached to the head brace and the active anchor; and
the head brace and the active anchor being positioned opposite each other along the extending member.

7. The therapeutic spinal traction device as claimed in claim 4 comprises:
a chest brace assembly;
the chest brace assembly comprises a chest shaft, a first arm, and a second arm;
the first arm comprises a first plurality of arm holes;
the second arm comprises a second plurality of arm holes;
the chest shaft being selectively engaged with one of the first plurality of beam holes and being selectively engaged one of the second plurality of beam holes;
the first arm being hingedly connected with the chest shaft;
the second arm being hingedly connected with the first arm opposite from the chest shaft; and
the second arm being hingedly connected with the extending frame opposite from the first arm.

8. The therapeutic spinal traction device as claimed in claim 7 comprises:
the first plurality of arm holes being positioned along the first arm;
the second plurality of arm holes being positioned along the second arm;
the first plurality of arm holes traversing through the first arm;
the second plurality of arm holes traversing through the second arm; and
an arm pin traversing through one of the first plurality of arm holes and one of the second plurality of arm holes.

9. The therapeutic spinal traction device as claimed in claim 4 comprises:
the first plurality of beam holes being positioned along the first beam;
the second plurality of beam holes being positioned along the second beam;
the first plurality of beam holes traversing through the first beam; and
the second plurality of beam holes traversing through the second beam.

10. The therapeutic spinal traction device as claimed in claim 2 comprises:
the elongated base comprises an at least one base anchor;
the at least one base anchor being mounted to the elongated base;
the at least one base anchor being positioned adjacent to the second base end;
the head brace being selectively coupled through an extending member to an active anchor, wherein the active anchor is selected from the at least one base anchor; and
the handle being pressed against the buttress.

11. The therapeutic spinal traction device as claimed in claim 10 comprises:
the extending member being attached to the head brace and the active anchor; and
the head brace and the active anchor being positioned opposite each other along the extending member.

12. The therapeutic spinal traction device as claimed in claim 2 comprises:
the height-adjustable post comprises an at least one post anchor;
the at least one post anchor being mounted to the height-adjustable post;
the at least one post anchor being positioned adjacent to the first post end;
the head brace being selectively coupled through an extending member to an active anchor, wherein the active anchor is selected from the at least one post anchor; and
the handle being pressed against the buttress.

13. The therapeutic spinal traction device as claimed in claim 12 comprises:
the extending member being attached to the head brace and the active anchor; and
the head brace and the active anchor being positioned opposite each other along the extending member.

14. The therapeutic spinal traction device as claimed in claim 1 comprises:
an anterior torso brace;
a foot support;
a locking pin;
the anterior torso brace comprises a brace hole;
the foot support comprises a foot hole;
the anterior torso brace being positioned opposite the cross member along the elongated base;
the brace hole being concentrically aligned with a desired hole of the plurality of base holes;
the foot support being adjacently positioned with the anterior torso brace opposite the cross member;
the foot hole being concentrically aligned with the brace hole; and
the locking pin traversing through the brace hole, the foot hole, and the desired hole.

15. The therapeutic spinal traction device as claimed in claim 12 comprises:
the foot support comprises a plurality of support holes and a foot rest;
the plurality of support holes being positioned along the foot support;
the plurality of support holes traversing through the foot support; and
the foot rest being selectively engaged with one of the plurality of support holes.
